(19) United States
(12) Patent Application Publication
(10) Pub. No.: US 2001/0005198 A1
(43) Pub. Date: Jun. 28, 2001

(54) Mouse for computer having an open/close click-button covers

(76) Inventors: Masanobu Sakamoto, Tokyo (JP); Tomoo Kanoya, Tokyo (JP)

Correspondence Address: FRISHAUF, HOLTZ, GOODMAN, LANGER & CHICK, P.C., 25th Floor, 767 Third Avenue, New York, NY, 10017, US

(21) Appl. No.: 09/746,723

(22) Filed: Dec. 21, 2000

(30) Foreign Application Priority Data
Dec. 28, 1999 (JP) 373089/1999

(51) Int. Cl. G09G 5/08

(52) U.S. Cl. 345/163

(57) ABSTRACT

A mouse 1 for computer is provided with a click button cover 2, which can be raised to open or closed optionally either a left click button 3 side or a right click button 3 side, and has a pushing part 4 corresponding to a click button 3 inside the cover.

### INDUSTRIAL FIELD OF THE INVENTION

The present invention relates to a mouse for computer use, and provides a novel mouse for computer use, which is improved so as to add a new function and also satisfy the taste of users, without losing existing feature in its functions and facilities.

### RELATED ARTS

Today, computer has been rapidly popularized, and mouse for operating the computer has been also commonly known, e.g., in its manner of using. Namely, at present, the mouse having two buttons for operating with clicking left or right button has been broadly popularized.

Although not so many ideas of adding new functions have been proposed on such a mouse, the improvement in its design has been made so as to provide improved facilities to use by fitting the design to the shape of user's hand, and it resulted the shape of mouse to differ considerably from that in its early stages.

In such existing technologies, the design has been improved indeed from the viewpoint of ergonomics to provide better facilities to use it. However, when the individuals have their personal computers for their personal use as in these days, much interest is directed not only to the facilities but also to how well user's taste is reflected to the device, and such a viewpoint has not ever been sufficiently considered in the development of the mouse for computer use.

Furthermore, since the mouse is a device used in cooperation with other peripheral operational devices such as a keyboard or the like, and thereby the mouse is usually kept near at hand even when the keyboard is used for inputting, it could cause a trouble to move meaninglessly the pointer on the display.

In order to solve such an erroneous operation, it becomes necessary to take such an action as to make the input from the mouse ineffective, when not intended to operate with the mouse. However, a mouse for computer use, in which such a viewpoint is taken into account, has not been proposed in the existing technologies.

### DISCLOSURE OF THE INVENTION

The present invention has been made after the repetition of experiments and discussions on solving the problem in the existing technologies as described above, and the invention proposes a mouse for operating computer wherein, fundamentally, the mouse is provided with a click button cover, which can be raised to open or closed optionally either a left click button side or a right click button side, and has a pushing part corresponding to a click button inside the cover, and, if necessary, the mouse may be further provided with an open/close actuator separately from the cover. Moreover, the mouse may be devised to suspend its function as a mouse when the click button cover is open. Still further, the mouse may have a patterned or colored surface, so that the mouse has an appearance to be a character of a small animal such as a mouse when the cover is open.

### BRIEF DESCRIPTION OF THE DRAWINGS

FIG. 1 is a set of illustrative diagrams of an example of configuration of the mouse according to the present invention, which is shown in a perspective view and a perspective sectional view.

FIG. 2 is a set of diagrams showing a hexahedral appearance of another configuration of the mouse according to the present invention.

FIG. 3 is a perspective view of the mouse as shown in FIG. 2, with the cover being closed.

FIG. 4 is a set of diagrams showing a hexahedral appearance of an example of configuration of the mouse according to the present invention, in which a click sensing part is provided inside the cover, and a character-like pattern is given to a portion of the mouse.

FIG. 5 is a set of perspective views showing various looks of several examples of the mouse according to the present invention, each of the entire surface of the mouse is patterned or colored.

FIG. 6 is a set of perspective views showing other several examples.

FIG. 7 is a set of perspective views showing still other several examples.

FIG. 8 is a set of perspective views showing still further examples.

In those figures, a numeral 1 denotes a computer mouse; 2 denotes a click button cover; 3 denotes a click button; 4 denotes a pushing part; 5 denotes a hinge; 6 denotes an open button; 7 denotes a tail-like projection; 8 denotes a ball; 9 denotes a cable; 10 denotes a portion covered by a cover; 11 denotes a click sensing means; and 12 denotes a character-like pattern, respectively.

### BEST EMBODIMENT OF THE INVENTION

The configuration of a specific embodiment according to the above-stated invention can be described as follows, on the basis of attached drawings.

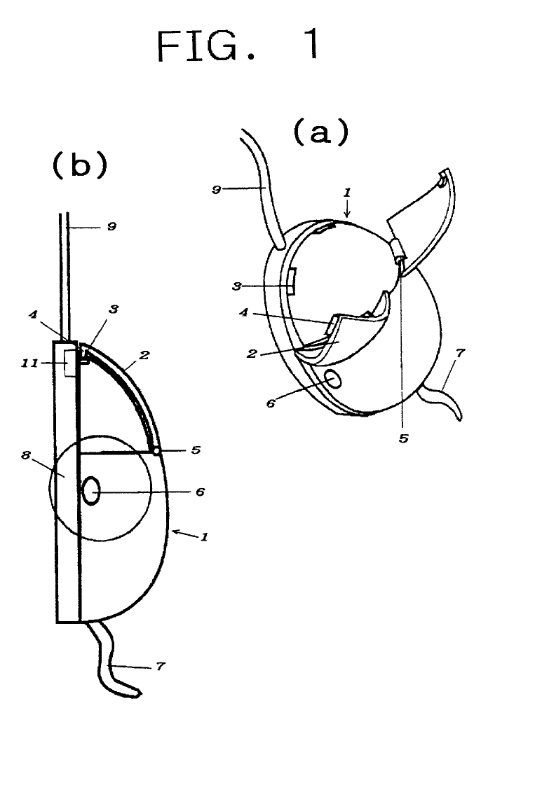

FIG. 1 is related to an example of configuration of the computer mouse 1 according to the present invention, (a) being a perspective view of the mouse with the click button cover 2 open, and (b) being a sectional perspective view showing the arrangement of the respective parts composing the computer mouse 1 according to the present invention, with the click button cover 2 closed.

That is, as shown in the figure, since the mouse 1 according to the present invention performs a click operation via the cover 2, and thereby the user does not have to touch directly a click button 3, the click button 3 can be formed quite small. Namely, a pushing part 4 for actuating the click button 3 to perform a click operation may be formed as a small protuberance inside the cover 2, so that the pushing part 4 is positioned to touch the click button 3 when the cover is closed.

When the mouse 1 according to the present invention is actually connected to a personal computer via a cable 9 or the like to perform various operations, as shown in FIG. 1(b), the mouse 1 can be used similarly to a common mouse by closing the cover 2 to make the pushing part 4 contact a click button 3. Each of the cover 2, 2, which are provided corresponding to respective left and right click buttons 3, 3, can be optionally opened and closed by a hinge 5, and held at either its open position as in FIG. 1(a) or its closed position as in FIG. 1(b), by properly employing a spring-and-stopper mechanism.

The open/close operation of the cover 2 may be performed manually, for example, by raising directly the cover 2 with user's hand. When the spring-and-stopper mechanism is employed to perform the open/close operation as mentioned above, an open button 6 may be also provided on any appropriate position of the mouse 1 according to the present invention, as can be seen in the figure, so that a stopper can be released by the open button 6 to raise the cover 2. Such a release operation of the stopper may be also realized by tilting or pulling a tail-like projection 7 of the illustrated mouse 1, instead of the open button 6.

Furthermore, in the present invention, since the mouse 1 with the cover 2 open is not used to operate computer, it is preferable to design the circuitry such that the connection between the mouse 1 and the computer is switched off whenever the cover 2 is open. That is, although a keyboard operation could lead to erroneously touching the mouse 1 to move irregularly the pointer on the display, or to cause an erroneous operation related to the content of the display, such a fear would be solved if the connection itself of the mouse 1 was switched off Here, in order to prevent an erroneous operation related to the pointer on the display, the function to be made ineffective should include not only the function to be actuated through the click button 3, but also the function to be actuated through a ball 8.

Such method of switching the connection off is not limited solely to the circuit design of the mouse 1, but it can be also realized by an electrical wiring, where the entire electrical connection to the mouse is broken when the cover 2 is open.

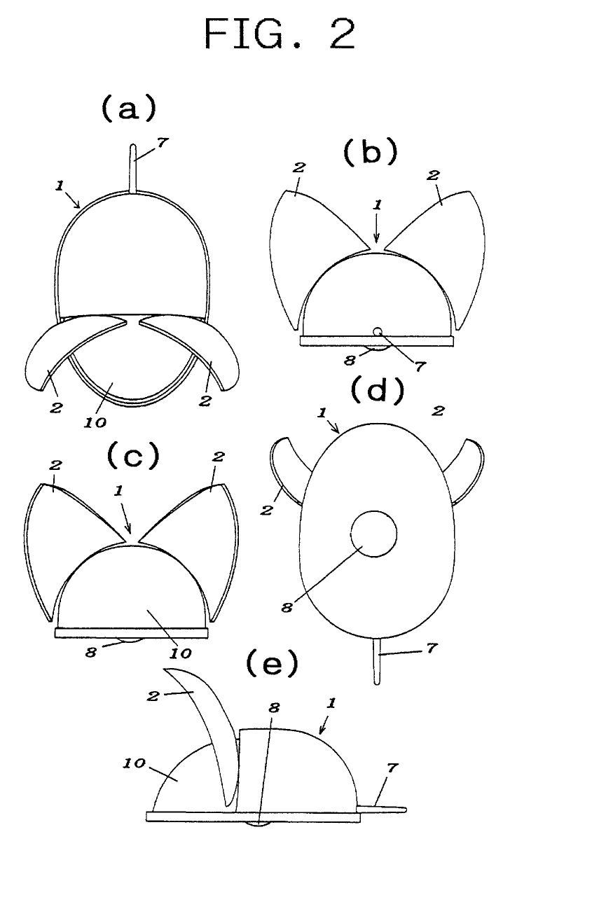

FIG. 2 is a set of diagrams showing a hexahedral appearance of another configuration of the mouse according to the present invention, which is configured somewhat differently from that of FIG. 1, and shown with the cover 2 open. Here, although the click button 3 and the pushing part 4 are not explicitly shown in the figure, the position where the click button 3 of the invention is to be disposed can be fundamentally selected freely to any place where it is covered by the cover 2 when cover 2 is closed. The pushing part 4 can be positioned, after the click button 3 is positioned in the area covered by the cover, such that the pushing part 4 formed inside the cover 2 contacts the click button 3 thus positioned. Accordingly, the technical feature of the present invention can be realized well, if the contacting relation is established between the click button 3 and the pushing part 4 when the cover 2 is closed, and therefore, the position of the click button 3 and the pushing part 4 can be also settled on any proper place other than shown in FIG. 1.

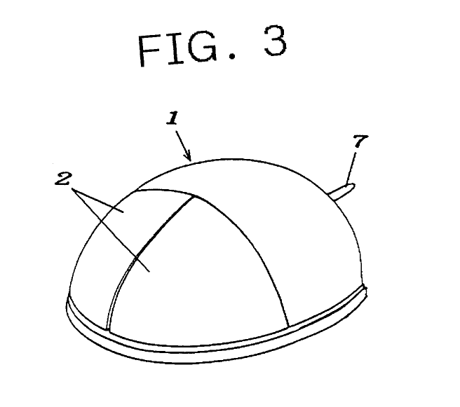

FIG. 3 is a perspective view of the computer mouse 1 according to the present invention as shown in FIG. 2, the mouse 1 being ready for functioning as a mouse with the cover 2 closed. The connection of the mouse 1 to the central computer may be a wired type with a cable 9 as shown in FIG. 1, or a mouse 1 of a wireless type like an infrared type may be also used within the technical feature of the present invention.

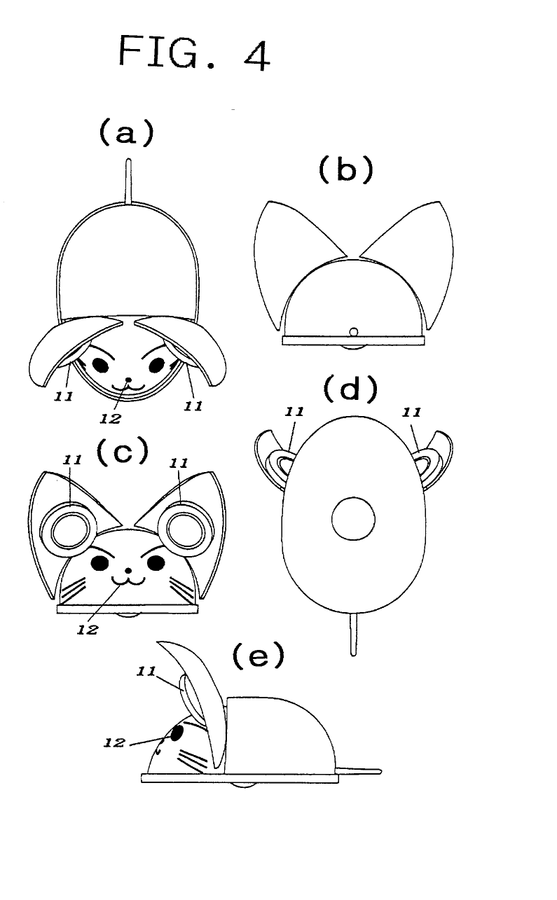

For a click sensing method, it is also possible to employ methods other than that shown above, for example, the click operation sensor means 11 may be provided inside the cover 2 as shown in FIG. 4, or the click operation sensor means 11 may be also provided closer to a hinge 5. In either case of those, it is preferable, as mentioned above, to design the circuitry so that it allows a click operation when the cover 2 is closed while it prohibits the click operation when the cover 2 is open.

At the same time, FIG. 4 shows a character-like pattern 12 of the face of a character, a mouse, provided on the surface of the mouse 1, where the cover 2 gives the looks of the imitation of ears of mouse when it is open, and, it is integrated with the character-like pattern 12, to give the mouse 1, as a whole, the looks of a character of mouse. Such a mouse product will satisfy the user of the mouse 1 in a sense of amusement. Furthermore, when the cover 2 is closed, the mouse 1 shown in FIG. 4 becomes substantially the same as that of FIG. 3, which has the same appearance as the common computer mouse.

The position of a connection cable 9 of the mouse according to the present invention to the central computer is preferably a place close to the click button 3 as shown in FIG. 1. However, it can be also disposed at any other desired place on the body of the mouse 1, provided that the place is not harmful to the facilities to use. In case a cordless type of the mouse 1 is employed, no connection cable 9 is necessary, of course.

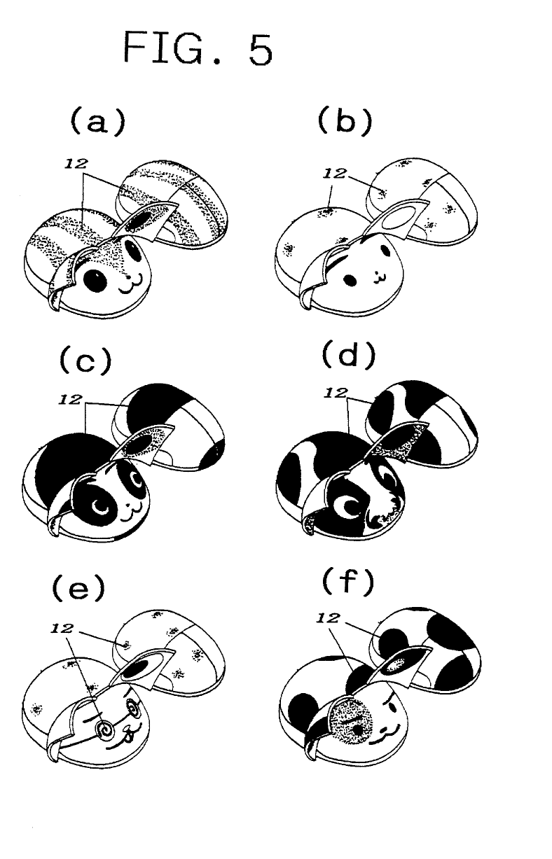

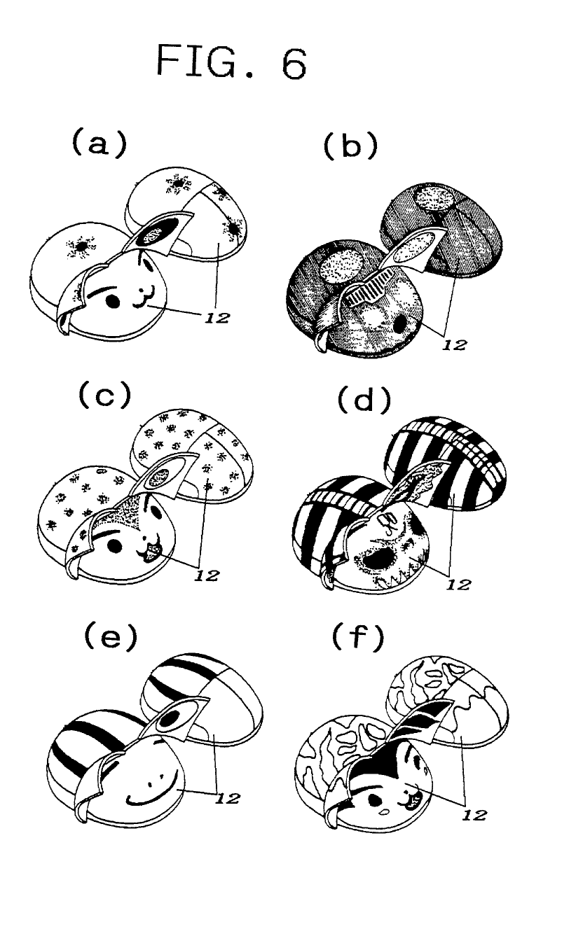

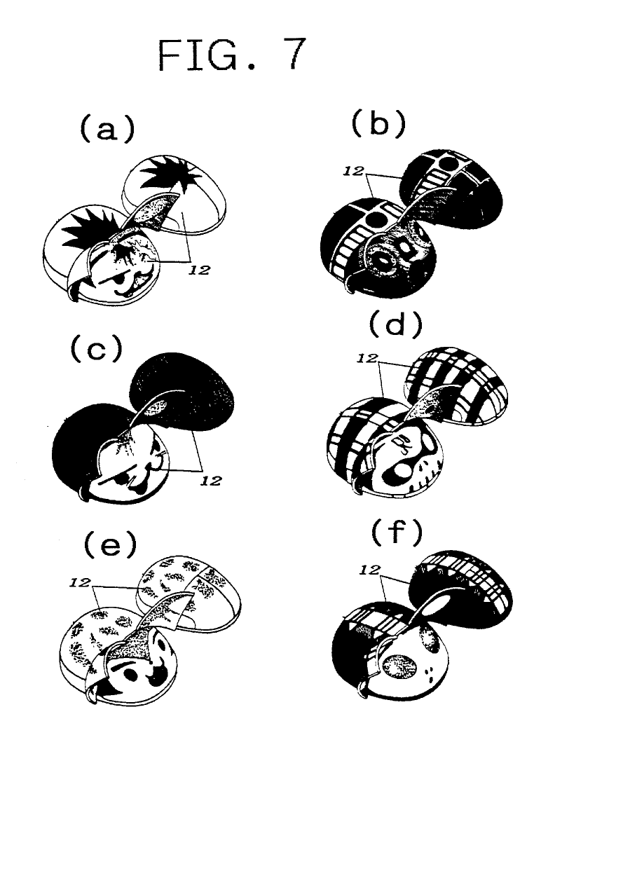

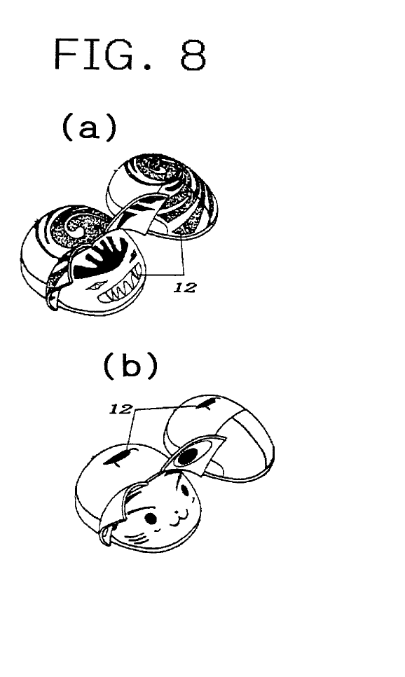

FIGS. 5-8 are several sets of perspective views showing the examples of mouse 1 according to the present invention, with their cover 2 open and closed, each of the examples being patterned or colored on the surface thereof to give various looks of characters. These examples include the mouse 1 having various patterns on their entire surfaces, differently from those which were patterned at only portions covered by their covers 2 as shown in FIG. 4, and thereby, it enables users to select correspondingly to their taste from a wide variety of the looks, even if the covers of those are closed. The situation of positioning the click button 3 and the pushing part 4 is the same as that described with referring to FIG. 2. Accordingly, any desired position is possible, only if the contacting relation is established between them when the cover 2 is closed.

Generally, it is a recent trend of the computer use that the personal use is rapidly growing in addition to the business use, and in such a trend, it has become more desirable that a personal sense of taste would be reflected not only on the wallpaper or screen saver of the display, but also on the product itself of the terminal and its peripherals such as a mouse, a keyboard, etc. Giving variation to the looks of a device or decorating it with patterns or colors in accordance with its situation in use, as in the mouse 1 according to the present invention, enables the computer users of individual level to have broader choice of devices from viewpoint of their sense of taste, and it meets a fashionable trend in these days.

By giving variation to the looks of the mouse 1 to broaden the user's choice, especially when a cordless type of mouse 1 is employed, each mouse 1 for individual use can be easily identified, even where a computer is commonly used by a plurality of operators on business. Furthermore, if antibacterial treatment was included in its specifications, the mouse 1 according to the present invention would be an effective solution to an issue of hygiene, importance of which is growing more in case where an equipment is commonly used by a plurality of people.

As clearly understood from earlier description, in the mouse 1 according to the present invention, the function as a mouse can be suspended when the cover 2 is open, and at the same time, one can also enjoy its looks as a cherishable mascot by the appearance colored and patterned. Accordingly, especially when a cordless type of mouse 1 is employed, it would be not incongruous if the mouse with the cover 2 open was placed as an ornament anywhere one likes, similarly to a mascot doll of, e.g., a stuffed animal, and therefore, a multiple usage of the mouse can be found from the viewpoint of a sense of taste or amusement as well.

### EFFECT OF THE INVENTION

In accordance with the present invention as described heretofore, it is possible to prevent an erroneous operation of a mouse, which would be caused by mis-touching the mouse when not intended to use it, by employing an open/close cover over a click button. Furthermore, the mouse can be designed as a product which can be also a mascot-like ornament when not used to the computer operation by making use of its peculiar appearance when the cover is open to give a pleasing appearance to the mouse appealing to the tastes of the user, which otherwise would give a mechanical-looking impression as a computer peripheral.

Additionally, these inventive functions does not give any obstacle to the existing functions of the mouse for computer operation, and accordingly, the present invention is an industrially valuable invention that satisfies multiple requirements of users.

We claim:

1. A mouse for computer having an open/close click-button cover wherein the mouse is provided with a click button cover, which can be raised to open or closed optionally either a left click button side or a right click button side, and has a pushing part inside the cover.

2. The mouse for computer having an open/close click-button cover as claimed in claim 1, wherein the mouse is provided with an open/close actuator separately from the cover.

3. The mouse for computer having an open/close click-button cover as claimed in claim 1, wherein the mouse suspends its function as a mouse when the click button cover is open.

4. The mouse for computer having an open/close click-button cover as claimed in claim 2, wherein the mouse suspends its function as a mouse when the click button cover is open.

5. The mouse for computer having an open/close click-button cover as claimed in claim 1, wherein the mouse has a patterned or colored surface, so that the mouse appears to be a character of a small animal such as a mouse when the cover is open.

6. The mouse for computer having an open/close click-button cover as claimed in claim 2, wherein the mouse has a patterned or colored surface, so that the mouse appears to be a character of a small animal such as a mouse when the cover is open.

7. The mouse for computer having an open/close click-button cover as claimed in claim 3, wherein the mouse has a patterned or colored surface, so that the mouse appears to be a character of a small animal such as a mouse when the cover is open.

8. The mouse for computer having an open/close click-button cover as claimed in claim 4, wherein the mouse has a patterned or colored surface, so that the mouse appears to be a character of a small animal such as a mouse when the cover is open.
